(19) United States
(12) Patent Application Publication
(10) Pub. No.: US 2007/0250630 A1
(43) Pub. Date: Oct. 25, 2007

(54) Method and a system of generating and evaluating potential resource allocations for an application

(76) Inventors: William H. Blanding, Nashua, NH (US); Manosiz Bhattacharyya, San Jose, CA (US); Jerry James Harrow JR., Nashua, NH (US); Glenna Mayo, Cupertino, CA (US); David Isaiah Seidman, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/411,045

(22) Filed: Apr. 25, 2006

(51) Int. Cl. G06F 15/173

(52) U.S. Cl. 709/226; 709/223

(57) ABSTRACT

Embodiments of the present invention are described which pertain to methods and systems of generating and evaluating potential resource allocations for an application. In one embodiment, metrics are associated with an application. Measurements for the metrics of the application are calculated. Potential resource allocations are generated based on the measurements of the metrics. A subset of the potential resource allocations are evaluated using a statistical model of the operation of the application.

### TECHNICAL FIELD

Embodiments of the present invention relate to allocating resources to applications. More specifically, embodiments of the present invention relate to generating and evaluating potential resource allocations for an application.

### BACKGROUND

In today's environment, resources such as processors, memory, firewalls, among other things, are dynamically allocated (also commonly known as “provisioned”) to applications when a need for the resources arises. Conventional workload management systems use simplistic methods for determining how to dynamically allocate resources. For example, if one application has more processors than what it needs, then some of its processors may be moved to another application that does not have enough processors. However, many applications, such as most applications in a data center, are very complex and difficult to analyze. Therefore, to date, only simple methods of determining the resources required by applications have been developed for use by conventional workload management systems. These simple methods result in an inadequate allocation of resources where in some cases resources are allocated to the wrong applications. Some applications are allocated too many resources while other applications are allocated too few resources. The resources that are or will be allocated to one or more applications shall be referred to herein as the actual resources allocated.

Frequently, the companies or organizations that own or operate the applications and the companies or organizations that provide the resources for the applications have agreements as to the level of service that will be provided to the applications. For example, they may agree that an application will be provided with at least a certain level of central processing unit (CPU) utilization. The level of service shall be referred to herein as a “service level objective” and the agreement shall be referred to herein as a “service level agreement.” Simplistic methods of determining how to allocate resources makes it difficult to meet the negotiated service level objective.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of various applications and resources that can be allocated to those applications, according to embodiments of the present invention.

FIG. 2 is a block diagram of a system for generating and evaluating potential resource allocations for an application, according to embodiments of the present invention.

FIG. 3 depicts a flowchart describing a method of generating and evaluating potential resource allocations for an application, according to embodiments of the present invention.

The drawings referred to in this description should not be understood as being drawn to scale unless specifically noted.

### DETAILED DESCRIPTION OF THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### Overview

According to embodiments of the present invention, a statistical model of the operation of an application is used as a part of evaluating different resource strategies for an application. In some embodiments, the statistical model is also used to select a preferred strategy for allocating resources to the application. A statistical model can be used to gather statistics about an application in order to obtain a knowledge base about the applications manner of operating for the purpose of using the knowledge base to evaluate a subset of potential resource requirements, according to embodiments as will become more evident.

The different resource strategies are based on resources allocations that could potentially be allocated to the application, according to embodiments of the present invention. For example, metrics that describe a resource or a type of resource can be associated with an application. An example of a metric is “CPU utilization.” Measurements are calculated for the metrics of the application, according to one embodiment. More specifically, the CPU utilization for the application can be measured. Assume for the purposes of illustration that the measured CPU utilization is 70%.

The measurements of the metric can be used to generate potential resource allocations. For example, four CPUs may be the actual resources that were allocated to the application when the measured CPU utilization was 70%. A subset of alternative resource allocations that could be potentially used for the application could be generated based on the actual resource allocation of four CPUs. The potential resource allocations are small variations of the actual resource allocation, according to one embodiment. In this illustration, the subset of the potential resource allocations could be three CPUs and five CPUs.

According to one embodiment, the statistical model evaluates the subset of potential resource allocations for example by receiving the subset of potential resource allocations and outputting service levels that the statistical model predicts would result if the potential resource allocations were actually used in allocating resources to the application. The service levels that the statistical model predicts shall be referred to herein as “predicted service levels.” The actual service level, which in this example resulted from four CPUs, and the predicted service levels can be evaluated to determine which respective resource allocation would provide a preferred resource allocation strategy. A preferred resource allocation strategy may result in the best performance or may alternatively result in the fewest resources that can be used by an application depending on which circumstance is needed, for example.

As a result of using a statistical model of the operation of an application to evaluate potential resource allocations, embodiments of the present invention are feasible, adaptive, do not require expert human knowledge of either the operation of the application or of methods for optimizing the operation of the application, can take into consideration the service level objective and provides a solution to a major problem that has needed resolution for a long time, among other things, as will become more evident.

### Resources

Resources can be any component that is hardware, software, firmware, or combination thereof that can be used to provide services rendered by an application, as will become more evident. For example, the resources can be servers, firewalls, load balancers, data backup devices, arrays of data storage disks, network appliances, Virtual Local Area Networks (VLANS), and network interface cards (NICs), among other things.

Actual resource allocation shall refer to information describing the resources that actually are or actually will be allocated to one or more applications. Potential resource allocation shall refer to information describing resources that could potentially be allocated to one or more applications. Once potential resource allocations have been evaluated, one of the potential resource allocations can be selected to become the actual resource allocation for the one or more applications, according to embodiments described herein, as will become more evident.

According to one embodiment, a subset of potential resource allocations are evaluated by a statistical model. Typically there are many different metrics associated with applications. All of the permutations or combinations of these different metrics result in many different potential resource allocations. Therefore, according to one embodiment of the present invention, a subset of the potential resource allocations is generated and evaluated.

There are many methodologies known in the art that can be used for selecting a subset of potential resource allocations. According to one embodiment, a methodology known as “local search” is used. Local search involves using small variations of the actual resource allocation to generate a subset of potential resource allocations. Continuing an example described herein, if four CPUs are actually allocated to an application, the subset of potential resource allocations could include three CPUs and five CPUs which are small variations from four CPUs.

A particular resource allocation may appear to be the best possible allocation of resources when in fact it is not. This phenomenon is commonly known in the art as “a local optimum.” According to embodiments of the present invention, other methodologies, such as genetic algorithms and Monte Carlo type statistical simulation algorithms can be used to periodically re-evaluate which of the potential resource allocations are to be selected as the subset of potential resource allocations for an application in order to correct a local optimum phenomenon. A Monte Carlo type algorithm typically utilizes a series of random numbers to perform multiple statistical simulations of a system, event, or process, and thus predict possible outcomes based on known or postulated inputs. A genetic algorithm typically utilizes random numbers to attempt to find an optimum solution to a problem through trial and error variance of various parameters while other parameters are held constant. In a genetic algorithm, good solutions are kept in a solution set. Two solutions from the solution set are then chosen as “parents” and elements of these parents are commingled in someway in an attempt to produce an offspring solution that is closer to an optimum solution. Repetitive iterations of genetic algorithms are typically used to build a solution set of possible solutions to a complex problem.

### Applications

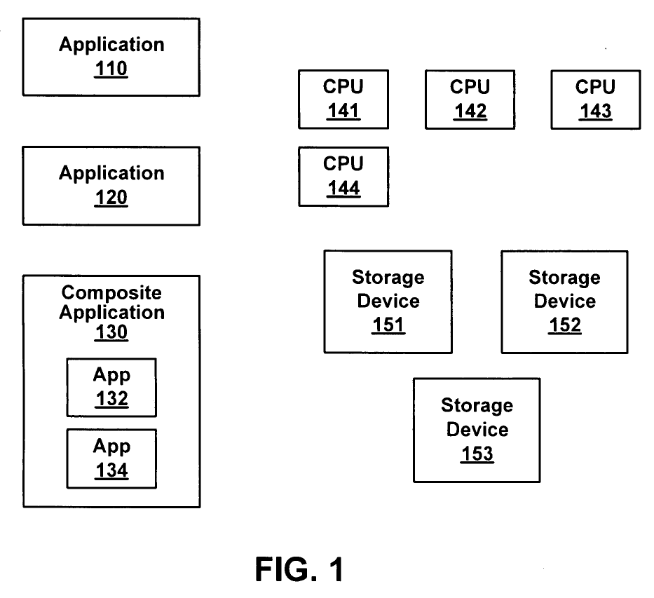

FIG. 1 is a block diagram of various applications and resources that can be allocated to those applications, according to embodiments of the present invention. The blocks that represent features in FIG. 1 can be arranged differently than as illustrated, and can implement additional or fewer features than what are described herein. Further, the features represented by the blocks in FIG. 1 can be combined in various ways.

FIG. 1 depicts applications 110, 120, 130, 132, and 134 and resources 141, 142, 143, 144, 151, 152, and 153. For the sake of simplicity, only CPUs 141, 142, 143, and 144 and storage devices 151, 152, and 153 are depicted for the resources.

The applications may be applications in a data center, for example, and the applications can be individual applications (110 and 120), or composite applications 130 that include related applications (132 and 134). The individual related applications (132 and 134) shall be referred to as component applications. Frequently, the applications (110, 120, 130, 132, and 134) are complex applications that many different types of resources can be or need to be allocated to and as a result many different metrics are associated with. According to one embodiment, component applications include groups of processes executing in a single operating system instance. Examples of component applications include but are not limited to web server applications, intermediate server applications for generating web pages, database managers for supplying data to the intermediate server applications and so on.

A composite application includes a group of related component applications that execute on the same or different operating system instances and that intercommunicate to accomplish some common purpose, according to one embodiment. The topology or structure of a composite application includes the relationships for interactions between the component applications associated with the composite application, according to one embodiment.

### Workload Management

Workload management is a procedure for determining what resources to allocate to applications in order to provide adequate performance, according to one embodiment. In managing resources, resources can be allocated to various applications or de-allocated from various applications. Further, resources can be moved. For example, a processor may be de-allocated from one application that is capable of performing adequately without the processor and then allocated to another application that is under performing.

As already stated, conventional workload management systems use very simple methods of determining what resources to allocate to applications. In contrast, according to embodiments of the present invention, a workload management system uses a statistical model of the operation of an application that has a knowledge base about the operation of an application and therefore can reflect the complex nature of many applications found in today's computing environments, as described herein.

### Metrics

Examples of metrics that can be associated with applications and measured include, but are not limited to, central processing unit (CPU) utilization, memory utilization, throughput (indication of Input/Output (I/O) bandwidth), the number of reads from or writes to storage devices, amount of data stored on memory and response time.

A metric can be for a type of resource or a particular resource. For example in the first case, the type of resource may be storage devices and the metric may be for memory utilization for all storage devices associated with a data center. In the second case, the resource may be one particular storage device allocated to one application and the metric may be the memory utilization for that one particular storage device.

According to one embodiment, the metrics for an application may be determined by a human analyst or may be automatically determined without expert human knowledge of the application.

According to embodiments of the present invention, a metric may be directly related to a resource or may have an indirect, but known, relationship to a resource. An example of the first case would be number of reads or writes to a storage device. An example of the later case would be CPU utilization which has an indirect but known relationship to the number of CPUs allocated to an application. More specifically, if the CPU utilization of an application is measured at 60% and five CPUs are currently allocated to that application, then mathematically it can be determined that the application would have a CPU utilization of 100% if three CPUs were allocated to that application. Further it could be mathematically determined that six CPUs would result in 50% CPU utilization, four CPUs would result in 75% CPU utilization and so on.

Measurements of the metrics associated with an application can be calculated periodically. For example, if the metrics for an application are CPU utilization and memory utilization, then the CPU utilization and the memory utilization can be measured at times T+0, T+1, T+2 and so on.

The measurements that are calculated periodically can be associated with a metric's vector. For example, the measurements at time T+0 can be associated with one metrics vector, the measurements at time T+1 can be associated with a second metrics vector, and so on.

Each element in the vector can be used to store a measurement for a particular metric. For example, if the metrics for an application are CPU utilization, the number of reads to a particular storage disk allocated to that application, and the amount of data stored on that same storage disk, then the CPU utilization for that application can be stored in the first element of the metric's vector, the number of reads to the storage disk can be stored in the second element of the metric's vector, and the amount of data stored on that storage disk can be stored in the third element of the metric's vector. At a later point in time, measurements can be retaken and stored in another metric's vector. According to one embodiment, one or more metric's vectors are the input for a statistical model, as will become more evident.

### Statistical Model

Embodiments of the present invention provide for the automatic management of resource allocation for an application by using a statistical model. Statistical models can be used for modeling the operation of an application, for example, by gathering lots of information in the form of statistics about an application over a period of time. Conventional statistical models are used to identify problems in the operation of an application or to predict potential problems in the operation of an application.

In contrast, according to embodiments of the present invention, a statistical model is used to enable the evaluation of a subset of potential resource requirements for an application. For example, a statistical model can be used to gather statistics about an application in order to obtain a knowledge base about the applications manner of operating for the purpose of using the knowledge base to evaluate a subset of potential resource requirements. Statistics can constantly be gathered about the application as it operates. Statistical models are designed to adjust themselves based on the statistics, thus, statistical models can be used to take into consideration new information about the application (e.g., is adaptive).

Metrics vectors [Mi] that include measurements that were taken for metrics associated with an application at times Ti [0, 1, 2, . . . ] and the actual service levels [Si] that were achieved by the resource allocations that resulted in the measurements can be used as input into the statistical model. The statistical model can use the metrics vectors and the actual service levels to acquire a knowledge base about the operation of the application.

Once the statistical model has a sufficient knowledge base about the operation of the application, the statistical model can additionally be used to evaluate potential resource requirements for the application, according to embodiments of the present invention. For example, as already described herein, a local search method can be used for deriving a subset of potential resource requirements. The subset of potential resource requirements can be used as input into the statistical model in the form of metrics vectors. The statistical model can use its knowledge base to output the service levels that the statistical model predicts would occur given the various potential resource requirements. A preferred resource allocation strategy can be selected based on the predicted service levels for the potential resource requirements. The preferred resource allocation strategy may result in the best performance or alternatively may result in the fewest resources that can be used by an application, depending on which circumstance is needed.

An example of a statistical model is Tree Augmented Bayesian Networks (TANs). TANs are well known in the field of statistical analysis as a means to classify data, statistically and visually model problems, evaluate solutions based on collected data, and represent relationships (visually if desired) among collected data. However according to embodiments of the present invention, any statistical model which can be used to predict service levels given certain potential resource requirements can be used. According to an embodiment, statistical models which may be derived without application specific knowledge from a human agent are used since resource management maybe completely automatic once the application is identified. However, statistical models which were implemented for specific applications can also be used. According to another embodiment, statistical models which are capable of modeling entire composite applications are preferred for evaluating potential resource requirements for a composite application since such statistical models can be expected to provide a more accurate representation of the relationships between the metrics and predicted service levels for a composite application.

### A System for Generating and Evaluation Potential Resource Allocations for an Application

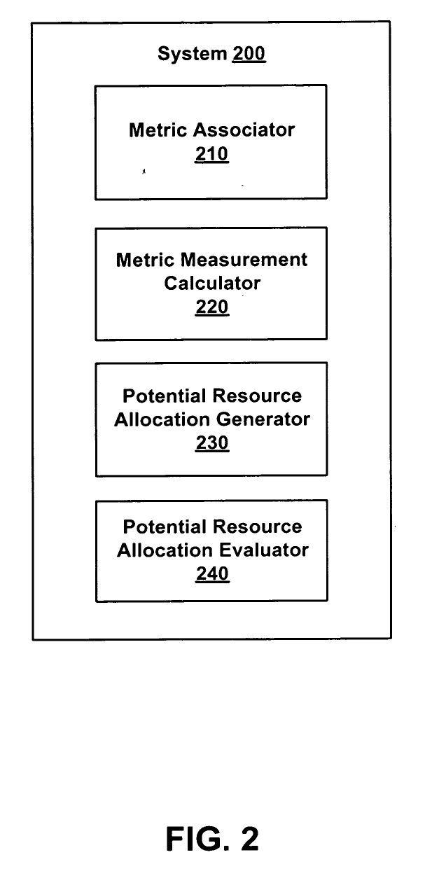

FIG. 2 is a block diagram of a system for generating and evaluating potential resource allocations for an application, according to embodiments of the present invention. The blocks that represent features in FIG. 2 can be arranged differently than as illustrated, and can implement additional or fewer features than what are described herein. Further, the features represented by the blocks in FIG. 2 can be combined in various ways. System 200 can be implemented with software, firmware, hardware, or with a combination thereof.

As depicted in FIG. 2, system 200 includes a metric associator 210, a metric measurement calculator 220, a potential resource allocations generator, and a potential resource allocations evaluator. Metric associator 210 associates metrics with an application, according to embodiments of the present invention. Metric measurement calculator 220 calculates measurements for the metrics of the application, according to embodiments of the present invention. Potential resource allocations generator 230 generates a subset of potential resource allocations based on the measurements of the metrics, according to embodiments of the present invention. Potential resource allocations evaluator 240 evaluates the subset of the potential resource allocations using a statistical model of the operation of the application, according to embodiments of the present invention.

### Operational Example for a Method of Generating and Evaluating Potential Resource Alloctions for an Application

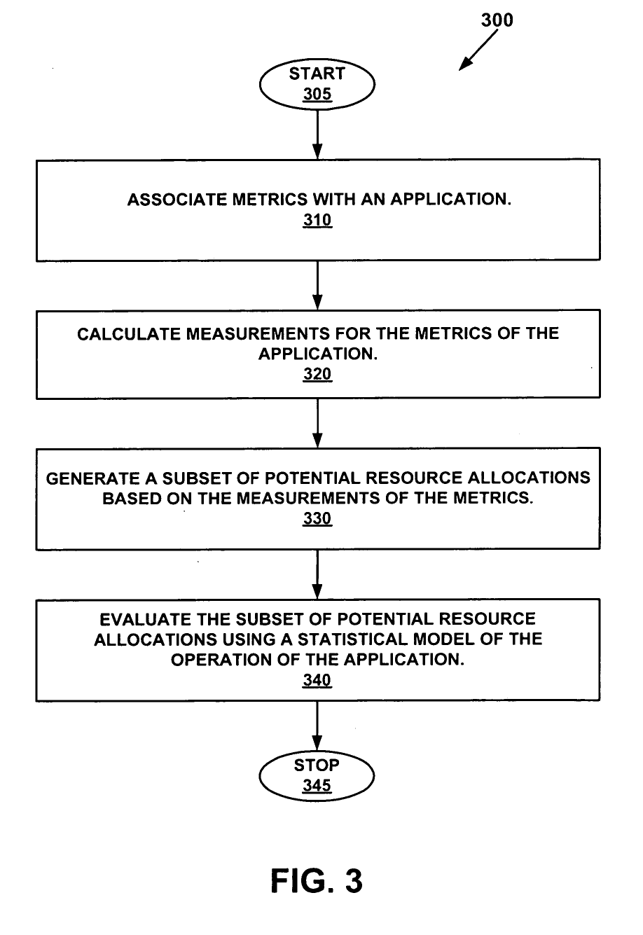

FIG. 3 depicts a flowchart 300 describing a method of generating and evaluating potential resource allocations for an application, according to embodiments of the present invention. Although specific steps are disclosed in flowchart 300, such steps are exemplary. That is, embodiments of the present invention are well suited to performing various other steps or variations of the steps recited in flowchart 300. It is appreciated that the steps in flowchart 300 may be performed in an order different than presented, and that not all of the steps in flowchart 300 may be performed.

All of, or a portion of, the embodiments described by flowchart 300 can be implemented using computer-readable and computer-executable instructions which reside, for example, in computer-usable media of a computer system or like device. As described above, certain processes and steps of the present invention are realized, in one embodiment, as a series of instructions (e.g., software program) that reside within computer readable memory of a computer system and are executed by the of the computer system. When executed, the instructions cause the computer system to implement the functionality of the present invention as described below.

For the purposes of illustration, the discussion of flowchart 300 shall refer to the structures depicted in FIG. 1 and FIG. 2. Further assume that CPUs 141, 142, and 143 and storage device 152 are allocated to application 120.

In preparation for flowchart 300, a statistical model can be used to gather statistics about an application 120 in order to obtain a knowledge base about the application 120's manner of operating. For the sake of illustration, assume that the statistics are gathered for times T+1 through T+6.

The process starts at step 305.

In step 310, metrics are associated with an application, according to embodiments of the present invention. For example, metrics such as CPU utilization of an application 120, the number of writes to a storage device 152 allocated to the application 120, and the amount of data stored on the storage device 152 are associated with the application 120. More specifically, a user can enter the metrics into a user interface, and a metrics associator 210 of a system 200 (FIG. 2) can be used for receiving information describing the metrics for the purpose of associating the metrics with the application 120. Alternatively, the metrics for the application 120 may be determined automatically, and the metrics associator 210 may receive the automatically determined metrics.

In step 320, measurements for the metrics of the application are calculated, according to embodiments of the present invention. For example, measurements can be taken for the metrics associated with the application 120. More specifically, at a particular time T+7, the metric measurement calculator 220 for the system 200 (FIG. 2) can measure the CPU utilization for the application 120, the number of writes to the storage device 152 allocated to the application 120, and the amount of data stored on the storage device 152.

In step 330, a subset of potential resource allocations is generated based on the measurements of the metrics, according to embodiments of the present invention. For example, the potential resource allocation generator 230 can use the local search methodology to generate a subset of potential resource allocations based on the measurements of the metrics. More specifically, if the application 120 at time T+7 was using three CPUs (141, 142, 143), then potential resource allocations could be two CPUs and four CPUs. Similarly, the local search methodology can also be used on the number of writes to the storage device 152, and the amount of data stored on the storage device 152.

In step 340, the subset of the potential resource allocations is evaluated using a statistical model of the operation of the application, according to embodiments of the present invention. For example, the potential resource allocation evaluator 240 can provide the subset of potential resource allocations to the statistical model of the application 120 in the form of one or more metrics vectors, as already described herein. The statistical model can use the knowledge base that it has acquired about the application 120 from time T0 to T6 to calculate predicted service levels for the potential resource allocations associated with the subset. The statistical model can return the predicted service levels to the potential resource allocation evaluator 240. The potential resource evaluator 240 can use the predicted service levels to select one of the potential resource allocations as the preferred resource allocation strategy.

The process stops at step 345.

The preferred resource allocation strategy can be used to allocate resources to the application 120.

Note, that many of the operations described herein can be performed in parallel. For example, the operations of gathering statistics about an application 120 to create a knowledge base, updating the knowledge base, measuring metrics, evaluating subsets of potential resource allocations, and the actual allocation of resources, among other things, can all be performed continuously and in parallel.

### CONCLUSION

Using a local search, according to embodiments of the present invention, to generate a subset of potential resource allocations is feasible. This is because the number of resource types and applications is generally small and only incremental changes to actual resource allocations are considered.

Embodiments of the present invention are adaptive, since a statistical model can be updated as automatic resource management is performed. If a resource allocation choice is made which results in a service level unexpectedly decreasing, this fact can be captured by the statistical model so that the next time a similar situation occurs, the statistical model can be more accurate in predicting a service level.

By using a statistical model of the operation of an application, among other things, embodiments of the present invention automatically derive and use information that describes the operation of the application to determine resource requirements without requiring expert human knowledge of either the operation of the application or of methods for optimizing the operation of the application. Thus, the expense in performing resource management is significantly reduced and significantly improved management of resources is feasible over that of conventional methods that were based on a lack of understanding of complex application operations.

System 200 (FIG. 2), according to embodiments of the present invention, is general purpose. This is because resource management can be performed without requiring specification of optimal or event efficient resource allocation algorithms (which are usually not known for many applications) and without requiring expert human knowledge about the application. Even if expert human knowledge of the application is available, it ordinarily involves expensive specialization of resource management software. Alternatively, conventional methodologies have used overly simplistic representations of application knowledge which may not involve great expense but do not capture the nuances of most application's operations.

System 200 (FIG. 2), according to embodiments of the present invention, is adaptive. This is because system 200 generates a subset of potential resource allocations, for example, using a local search as described herein. Further, the statistical model can constantly be updated as a result of prior resource allocation decisions and subsequent allocation decisions are improved as a result of the increased information about the application that is incorporated into the statistical model.

The prime consideration of owner's of applications is the service level that is achieved by the application. According to embodiments of the present invention, resource allocation decisions are directly tied to the application's service level, which results in increased customer satisfaction.

Although there has been a tremendous need for inexpensive models that enable the evaluation of potential resource allocations which do not require a lot of human expertise in evaluating an application, statistical models of application's operations have never been used by conventional workload management systems. Thus, embodiments of the present invention can be used to solve a major problem that has been felt for a long time.

What is claimed is:

1. A method of generating and evaluating potential resource allocations for an application, the method comprising:
associating metrics with an application;
calculating measurements for the metrics of the application;
generating a subset of potential resource allocations based on the measurements of the metrics; and
evaluating the subset of potential resource allocations using a statistical model of the operation of the application.

2. The method as recited in claim 1, wherein the associating of the metrics with the application further comprises:
associating metrics selected from a group consisting of:
CPU utilization, amount of memory, throughput, number of reads from a storage device, number of writes to a storage device, amount of data stored on a storage device, and response time.

3. The method as recited in claim 1, wherein the associating of the metrics with the application further comprises:
associating metrics selected from a group consisting of:
a metric that represents a type of resource, and a metric for a particular resource.

4. The method as recited in claim 1, wherein the evaluating the subset of potential resource allocation using the statistical model of the operation of the application further comprises:
using predicted service levels for the subset of potential resource allocations to select a preferred resource allocation strategy, wherein the statistical model provides the predicted service levels.

5. The method as recited in claim 1, wherein the evaluating the subset of potential resource allocation using the statistical model of the operation of the application further comprises:
evaluating the subset of potential resource allocation using a Tree Augmented Bayesian Networks (TANs) model.

6. The method as recited in claim 1, wherein the generating of the subset of potential resource allocations based on the measurements of the metrics further comprises:
using a local search methodology to generate the subset of potential resource allocations based on the measurements of the metrics.

7. The method as recited in claim 1, wherein the method further comprises:
periodically re-evaluating the subset of potential resource allocations to correct a local optimum phenomenon.

8. A system of generating and evaluating potential resource allocations for an application, the method comprising:
a metric associator for associating metrics with an application;
a metric measurement calculator calculating measurements for the metrics of the application;
a potential resource allocations generator for generating a subset of potential resource allocations based on the measurements of the metrics; and
a potential resource allocations evaluator for evaluating a subset of the potential resource allocations using a statistical model of the operation of the application.

9. The system of claim 8, wherein the metrics are selected from a group consisting of:
CPU utilization, amount of memory, throughput, number of reads from a storage device, number of writes to a storage device, amount of data stored on a storage device, and response time.

10. The system of claim 8, wherein the metrics are selected from a group consisting of:
a metric that represents a type of resource, and a metric for a particular resource.

11. The system of claim 8, wherein the potential resource allocation evaluator uses predicted service levels for the subset of potential resource allocations to select a preferred resource allocation strategy, wherein the statistical model provides the predicted service levels.

12. The system of claim 8, wherein the statistical model is a Tree Augmented Bayesian Networks (TANs) model.

13. The system of claim 8, wherein the potential resource allocation generator uses a local search methodology to generate the subset of potential resource allocations based on the measurements of the metrics.

14. The system of claim 8, wherein the system periodically re-evaluates the subset of potential resource allocations to correct a local optimum phenomenon.

15. A computer-usable medium having computer-readable program code embodied therein for causing a computer system to perform a method of generating and evaluating potential resource allocations for an application, the method comprising:
associating metrics with an application;
calculating measurements for the metrics of the application;
generating a subset of potential resource allocations based on the measurements of the metrics; and
evaluating the subset of potential resource allocations using a statistical model of the operation of the application.

16. The computer-usable medium of claim 15, wherein the computer-readable program code embodied therein causes a computer system to perform the method, and wherein the associating of the metrics with the application further comprises:
associating metrics selected from a group consisting of:
CPU utilization, amount of memory, throughput, number of reads from a storage device, number of writes to a storage device, amount of data stored on a storage device, and response time.

17. The computer-usable medium of claim 15, wherein the computer-readable program code embodied therein causes a computer system to perform the method, and wherein the associating of the metrics with the application further comprises:
associating metrics selected from a group consisting of:
a metric that represents a type of resource, and a metric for a particular resource.

18. The computer-usable medium of claim 15, wherein the computer-readable program code embodied therein causes a computer system to perform the method, and wherein the evaluating the subset of potential resource allocation using the statistical model of the operation of the application further comprises:
using predicted service levels for the subset of potential resource allocations to select a preferred resource allocation strategy, wherein the statistical model provides the predicted service levels.

19. The computer-usable medium of claim 15, wherein the computer-readable program code embodied therein causes a computer system to perform the method, and wherein the generating of the subset of potential resource allocations based on the measurements of the metrics further comprises:
using a local search methodology to generate the subset of potential resource allocations based on the measurements of the metrics.

20. The computer-usable medium of claim 15, wherein the computer-readable program code embodied therein causes a computer system to perform the method, and wherein the method further comprises:
periodically re-evaluating the subset of potential resource allocations to correct a local optimum phenomenon.
